(19) United States
(12) Patent Application Publication
(10) Pub. No.: US 2010/0247275 A1
(43) Pub. Date: Sep. 30, 2010

(54) AUTOMATED STOWAGE AND RETRIEVAL SYSTEM

(75) Inventors: James P. Karlen, Bethel, OH (US); Hans Frederich Paul Karlen, Bethel, OH (US); Phillip J. Schneider, Batavia, OH (US); Theodore H. Leist, Bethany, OH (US); Michael D. Conners, Cincinnati, OH (US); Thomas R. McCammon, West Chester, PA (US); Paul H. Eismann, Florence, KY (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: Agile Systems Inc., Bethel, OH (US)

(21) Appl. No.: 11/552,845

(22) Filed: Oct. 25, 2006

Related U.S. Application Data
(60) Provisional application No. 60/729,964, filed on Oct. 25, 2005.

(51) Int. Cl. B65G 1/00

(52) U.S. Cl. 414/286; 414/331.01; 414/807

(57) ABSTRACT

Storage and retrieval systems and methods are provided to automate the process of handling a mixed inventory of palletized and containerized items. In one embodiment, the stowage and retrieval system comprises a storage area comprising a plurality of stationary cell modules arranged in a matrix, wherein each cell module comprises at least one motor. The system also comprises a plurality of carriers comprising at least one magnet disposed on an underside of each of the carriers and at least one engagement mechanism disposed on a top side of each of the carriers. The at least one magnet of the carrier is configured to engage the at least one motor of a corresponding cell module, and the at least one motor is configured to move the carrier within the storage area.

### CROSS-REFERENCE TO RELATED APPLICATION

This application claims priority from U.S. Provisional Patent Application Ser. No. 60/729,964 filed Oct. 25, 2005, the entire disclosure of which is hereby incorporated by reference herein.

### TECHNICAL FIELD

The present invention relates generally to an automated stowage and retrieval system designed to accommodate palletized and containerized freight of various dimensions. While the invention has utility in a variety of environments, embodiments are specifically disclosed in connection with a shipboard system for handling cargo and weapons within the holds and magazines of naval vessels or other ships at sea, providing means to automatically stow and retrieve any individual palletized or containerized payloads contained therein, to stow such payloads as densely as possible within the three-dimensional volume of a given hold or magazine, and to automatically secure individual payloads and stacks of payloads for safe transit in the storeroom and during conveyance to other locations

### BACKGROUND OF THE INVENTION

Cargo and weapons bound for a naval vessel or other type of ship are normally packaged for transportation and stowage in one of two ways: goods are either secured to a pallet or are enclosed in a shipping container. Based on a typical inventory of weapons and stores aboard a current-generation aircraft carrier or other surface combatant, most pallets measure 44 inches in length by 40 inches in height and can weigh as much as 3,800 pounds. Containerized loads, in which the cargo or weapons are fully enclosed in a rigid box, can weigh up to 9,640 pounds, with lengths up to 312 inches. Individual pallets and containers of all types and sizes are handled many times by various crews and equipment and may be restowed in the holds of several different ships before reaching their ultimate point of use.

Such palletized and containerized cargo and weapons payloads are generally first moved from locations in pierside warehouses or weapons storage depots to staging areas on a dock using forklift trucks. They are then hoisted onto the top deck of a shuttle ship or a specialized cargo vessel called an Underway Replenishment (UNREP) ship using conventional cranes. Once aboard the UNREP ship, the pallets and containers are again moved with forklifts, pallet movers, or sometimes cranes to one of several elevators, where they are lowered for stowage into a hold or magazine on one of the vessel's five or six cargo decks.

After descending to the appropriate hold or magazine, each pallet or container is removed from the elevator platform using another forklift truck and is deposited at its particular stowage site in the storeroom, where it is usually stacked on identical pallets or containers to the maximum height permitted by either container capacity or the height of the storeroom ceiling. Each individual load or stack is then manually secured to the deck for safe transit at sea using tie-down straps, chains, nets or blocking. When the time comes to transfer the pallets and containers from the UNREP ship to a surface combatant during transit at sea, the procedure is reversed. After the cargo is delivered to the combatant ship via connected replenishment gear or aircraft, the same procedures are again employed, using a series of lift trucks and elevators to restow the pallets and containers in holds and magazines located below decks.

This stowage and retrieval process is extremely time-consuming, manpower-intensive, and inefficient. For example, during the cargo retrieval process, forklift operators in each hold or weapons magazine must select the pallet or container that has been ordered, manually remove the tie-down straps, chains, nets or other restraining devices that were previously installed to secure it to the hold deck for safe transit at sea, and then pick up the load, maneuver it between the other stored cargo, and deliver it to the elevator trunk. When the elevator platform becomes available, the forklift drives onto the platform and deposits the payload. The elevator often must wait until several of the weapons or cargo payloads requested from that magazine or hold have been acquired and loaded before it can deliver the goods to their destination, delaying parallel activities in the other magazines and holds that the elevator services.

Forklift trucks, which are typically the prime movers for horizontal operations in this entire sequence of events, have certain intrinsic disadvantages for this application. First, they require aisles to be cleared within which to maneuver the payloads, and space to access each with their tines, so the cargo in each hold or magazine is repeatedly rearranged to acquire requested payloads. A considerable amount of floor space must be left vacant to provide sufficient maneuvering room for the forklifts and for temporary cargo staging areas. As a result, payloads cannot be stowed as densely as desired. Second, forklift trucks are by-nature quite heavy themselves and thus place undue stress on the elevator platform and its actuator system when driven onto the freight elevator carrying individual payloads. Third, as discussed, payloads must be unloaded from or loaded onto the freight elevator platform one at a time, so the elevator must wait until each is individually stowed or retrieved. Fourth, forklifts have proved to be quite maintenance-intensive and costly over their service life. Finally, this cargo and weapons stowage and retrieval process must often be performed in high seas, where even the largest surface vessels, such as aircraft carriers, pitch and roll violently. In certain sea states, handling large and heavy palletized and containerized loads with forklift trucks becomes unsafe and the process must be stopped.

Conventional “rack-and-aisle” automated storage and retrieval systems used today in land-based warehouses also have significant limitations. First, these systems are capable of handling payloads of only one size and shape, typically pallets. Second, in order to achieve selective access, i.e., the ability to access any individual payload contained in the system, one fixed, empty aisle must be provided between every two storage racks to provide access to every cargo unit, or empty rack space must be reserved to allow payloads to be shuffled from one rack to another. In either case, high storage density cannot be achieved. Finally, these industrial warehousing systems are not designed for shipboard applications in which the cargo contained is subject to high dynamic loads caused by ship motion and must be restrained at all times.

Despite continuing efforts on the part of the Navy and commercial operators to maximize efficiency in transporting, handling and stowing palletized and containerized cargo and weapons of various sizes and shapes at sea, current systems have limitations in stowage density, speed of access, and securing of payloads. Accordingly, automated stowage and retrieval systems are desired that achieve high three-dimensional stowage density within a given hold or magazine, that permit any payload contained in the storeroom to be accessed, loaded and unloaded on associated service elevators quickly, and/or that automatically secure those payloads for transit in rough seas.

### SUMMARY

In accordance with one embodiment, an automated stowage and retrieval system is provided. The system comprises a storage area comprising a plurality of stationary cell modules arranged in a matrix, wherein each cell module comprises at least one motor. The system also comprises a plurality of carriers comprising at least one magnet disposed on an underside of each of the carriers. Each carrier comprises at least one engagement mechanism for a payload interface disposed on a top side of each of the carriers, wherein the at least one magnet is configured to engage the at least one motor of a corresponding cell module. Moreover, the at least one motor is configured to move the carrier within the storage area and stabilize the carrier when the plurality of carriers are at a rested position. Additionally, each carrier is configured to engage with a corresponding cell module such that all but one or two cell modules engages a corresponding carrier at a rested position.

In accordance with another embodiment, a payload interface for providing access to and transporting a desired payload is provided. The payload interface comprises a support frame, and a plurality of support stanchions extending from a surface of the support frame. Each stanchion comprises a locking receptacle at one end of the stanchion, a locking insert disposed at an opposite end of the stanchion, and an extendible rod connecting the locking insert and locking receptacle, wherein the locking inserts are configured to engage a locking receptacle of another carrier, or a locking receptacle of another payload interface.

In accordance with yet another embodiment, a method of moving carriers between cell modules of a storage area matrix is provided. The method comprises providing a first cell module comprising at least one linear synchronous motor, a second cell module comprising at least one linear synchronous motor, and a carrier comprising at least one magnet which is coupled to the at least one motor of the first cell module. The method further comprises transferring the carrier from the first module to the second cell module by delivering a thrust force from the at least one linear synchronous motor of the first cell module, wherein the thrust force decouples the at least one magnet from the first linear synchronous motor and delivers the carrier to the second cell module for subsequent coupling of the at least one magnet to the at least one linear synchronous motor of the second cell module

Additional features and advantages provided by the systems and methods of the present invention will be more fully understood in view of the following detailed description, in conjunction with the drawings

### BRIEF DESCRIPTION OF THE DRAWINGS

The following detailed description of the illustrative embodiments of the present invention can be best understood when read in conjunction with the following drawings, where like structure is indicated with like reference numerals and in which:

FIG. 1a is a schematic illustration of a storage area matrix according to one or more embodiments of the present invention;

FIG. 1b is a schematic illustration of the “slide-puzzle” principle according to one or more embodiments of the present invention;

FIG. 2a is an orthographic view of the internal components of a cell module according to one or more embodiments of the present invention;

FIG. 2b is another orthographic view of a cell module with the internal components covered according to one or more embodiments of the present invention;

FIG. 2c is a cross-sectional view of a cell module and a carrier according to one or more embodiments of the present invention;

FIG. 3a is an orthographic view of a top side of a carrier according to one or more embodiments of the present invention;

FIG. 3b is an orthographic view of an under side of a carrier according to one or more embodiments of the present invention;

FIG. 3c is an exploded view of a receptacle according to one or more embodiments of the present invention;

FIG. 4 is a cross-sectional view illustrating the engagement of a cell module and a carrier according to one or more embodiments of the present invention;

FIG. 5a is an orthographic view of an payload interface according to one or more embodiments of the present invention;

FIG. 5b is a cross-sectional view of a locking insert and a locking receptacle prior to engagement via a screw locking mechanism according to one or more embodiments of the present invention;

FIG. 5c is a cross-sectional view of a locking insert and a locking receptacle upon engagement via a screw locking mechanism according to one or more embodiments of the present invention;

FIG. 5d is a cross-sectional view of a locking insert and a locking receptacle upon engagement via a ball locking mechanism according to one or more embodiments of the present invention;

FIG. 5e is a cross-sectional view of a locking insert and a locking receptacle prior to engagement via a ball locking mechanism according to one or more embodiments of the present invention;

FIG. 5f is an orthographic view of stacked payload interfaces and nested payloads disposed thereon according to one or more embodiments of the present invention;

FIG. 5g is an orthographic view of a payload interface comprising multiple shelves according to one or more embodiments of the present invention;

FIG. 6a is a side view of a robotic manipulating unit according to one or more embodiments of the present invention;

FIG. 6b is a cross-sectional view illustrating the engagement of a robotic manipulating unit and a payload interface, and specifically illustrating the actuators of the robotic manipulating unit according to one or more embodiments of the present invention;

FIG. 7a is an orthographic view of an omni-directional guided vehicle (OGV) according to one or more embodiments of the present invention;

FIG. 7b is an orthographic view of the internal components of an omni-directional guided vehicle (OGV) according to one or more embodiments of the present invention;

FIG. 8a is a schematic view of a control system for the storage area matrix according to one or more embodiments of the present invention; and

FIG. 8b is a flow chart of an overall control system, which incorporates matrix control system of FIG. 8a, according to one or more embodiments of the present invention.

### DETAILED DESCRIPTION OF ILLUSTRATIVE EMBODIMENTS

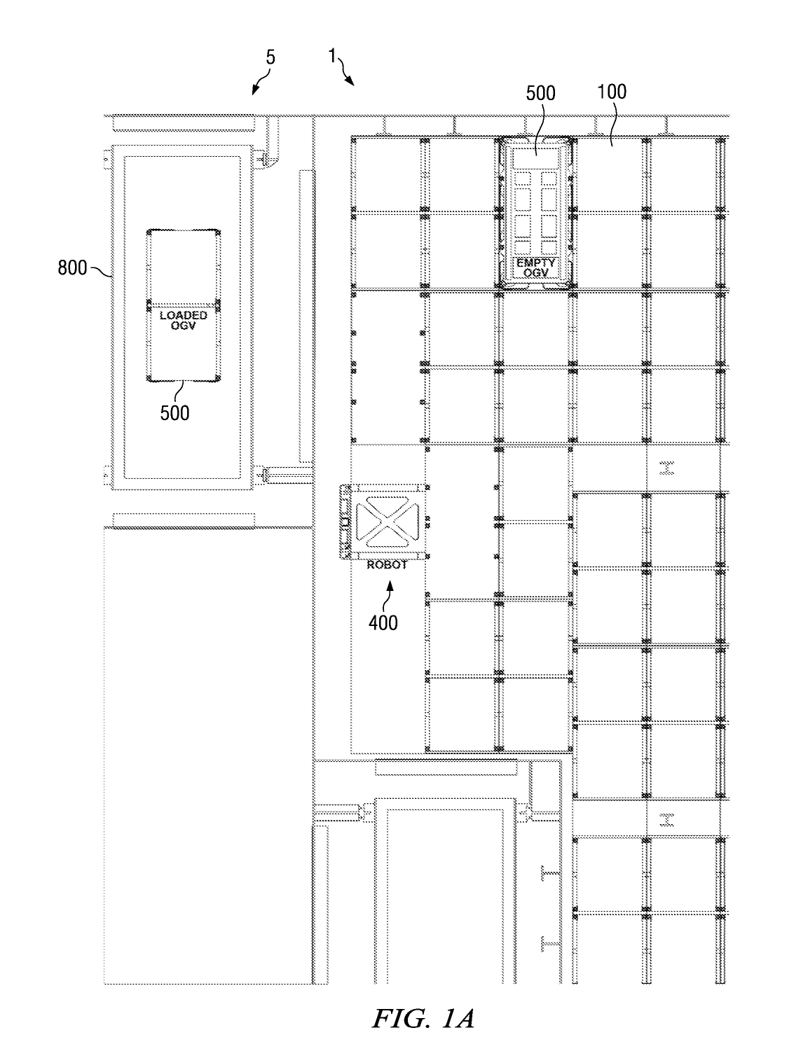

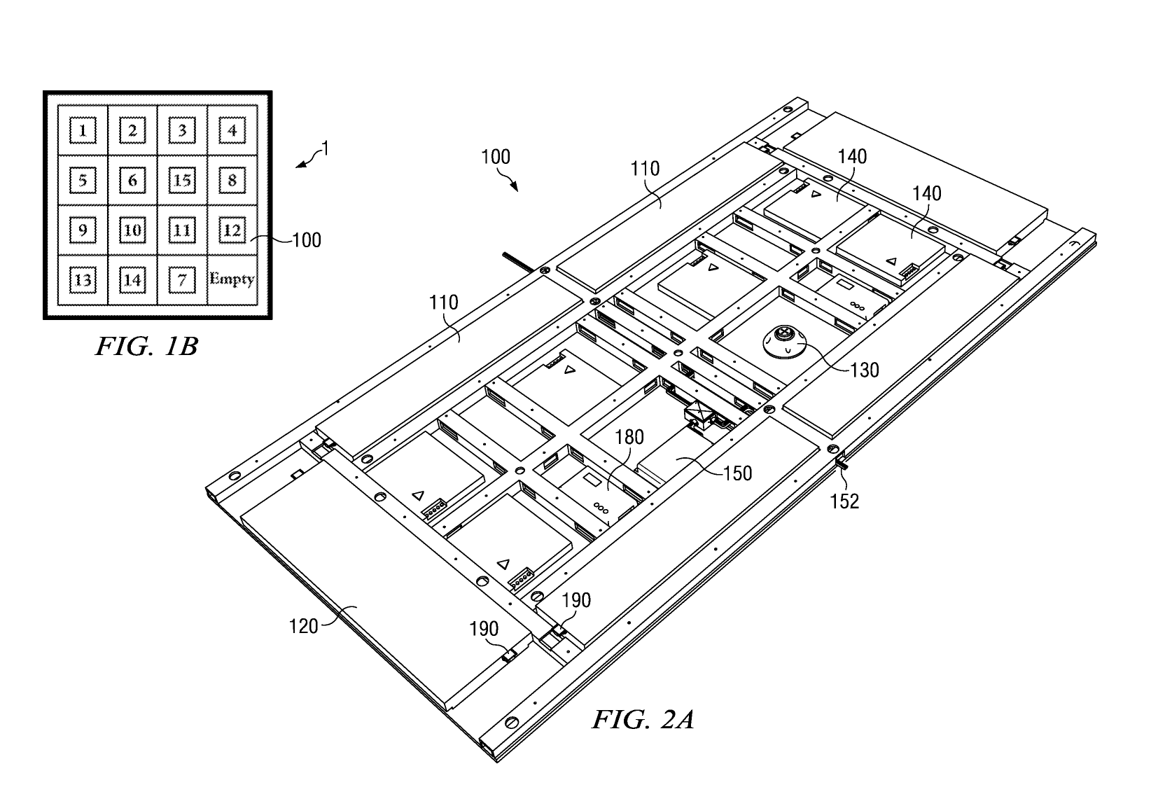

The automated stowage and retrieval system of the present invention is directed to maximizing the amount of cargo in a limited three-dimensional space. Referring to FIGS. 1a and 1b, the illustrated embodiment utilizes a “slide-puzzle” principle to maximize storage capacity, while facilitating easy access to cargo in an expedited manner. Under the “slide puzzle” principle, a storage area is divided into a storage area matrix 1, wherein every cell module 100 comprises a moving carrier and cargo disposed thereon, except for one or two empty cell modules. By using all but one or two cell modules, the storage space may stow more cargo than previously was possible with conventional rack and aisle operations. Further resulting from the one or two empty spaces, the system devises a carrier movement scheme through the use of a computer controlled indexing algorithm based on the “sliding puzzle” principle. In this carrier movement scheme, a payload carrier in the back corner of a storage area may be moved to the front of the storage area matrix through the coordinated movement of one or more carriers. For more details on the “slide puzzle” principle, U.S. Pat. No. 6,842,665 is incorporated by reference herein, in its entirety. The system components and integrated control framework utilized in this automated system will be discussed in detail below

As stated above, the system comprises a storage area 1 comprising a plurality of stationary cell modules 100 arranged in a matrix. The storage area 1 may constitute any three dimensional storage location, warehouse, or facility suitable for stowing containers or palletized loads. In an exemplary embodiment, the storage area 1 is a hold of a ship, configured to stow cargo, e.g. weapon payloads. “Payload”, as used herein, refers to cargo and supplies, especially cargo such as military pallets comprising bombs, missiles, grenades, and combinations thereof.

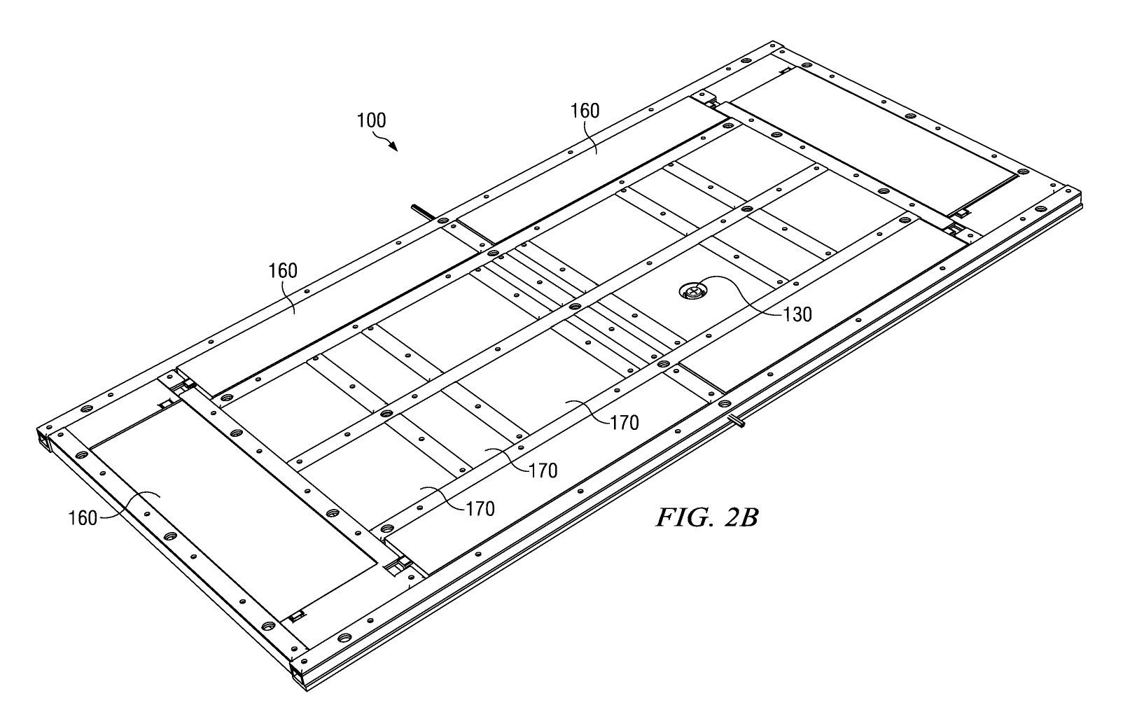

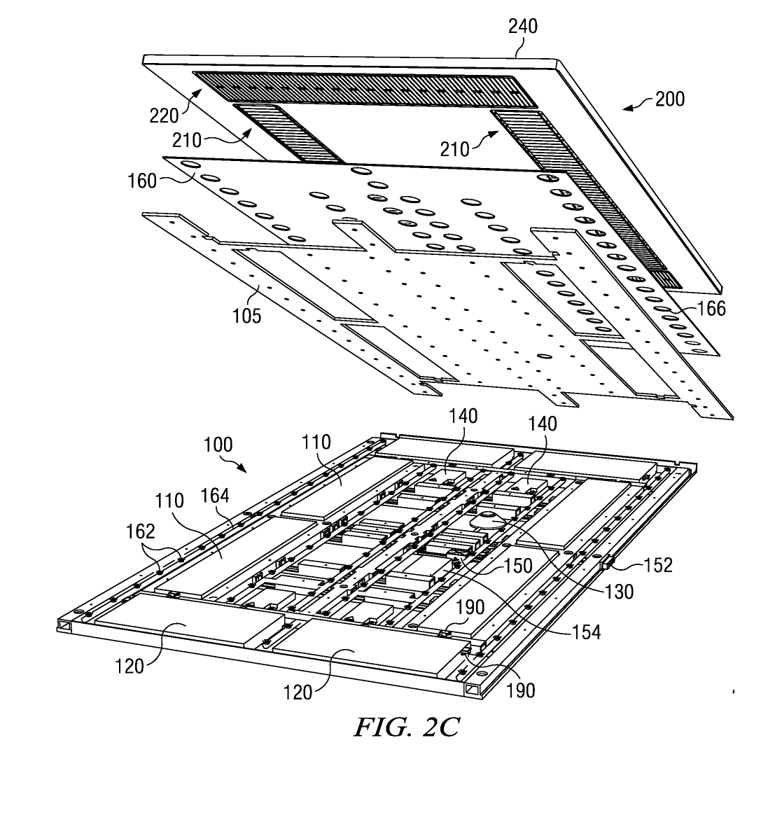

Each cell module 100 is a permanent structure embedded in or permanently mounted to the floor of a storage area 1. In the embodiments of FIGS. 2a-2c, the cell module 100 defines a substantially flat rectangular plate structure, but other shapes and dimensions are also possible. Although the cell modules 100 are permanent structures, it is contemplated that they may be removed from the floor, for example, if it is necessary to detach the modules from the floor for repair or replacement. Referring to FIGS. 2a through 2c, the cell modules 100 comprise at least one motor 110, 120. In an exemplary embodiment, the at least one motor may comprise linear synchronous motors, for example, short drive linear synchronous motors 120, long drive linear synchronous motors 110, or combinations thereof. In a further exemplary embodiment, the motors 110, 120 may comprise iron-core linear synchronous motors, for example, and not by way of limitation, the IC55-250 Direct Drive Linear Synchronous Motor Assembly manufactured by Kollmorgen.

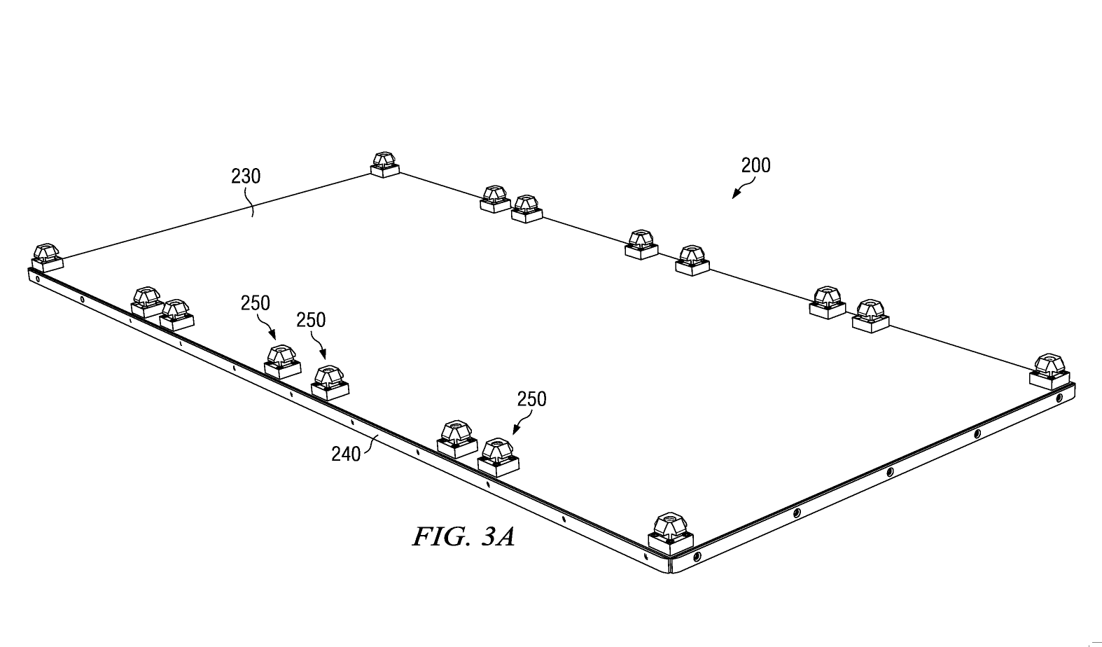

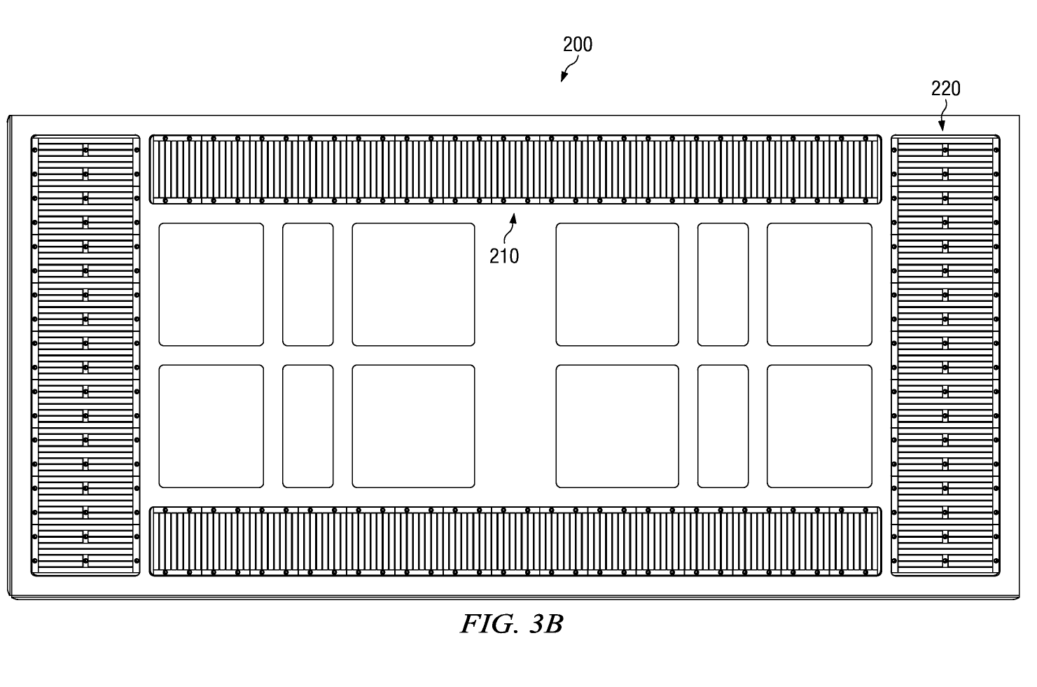

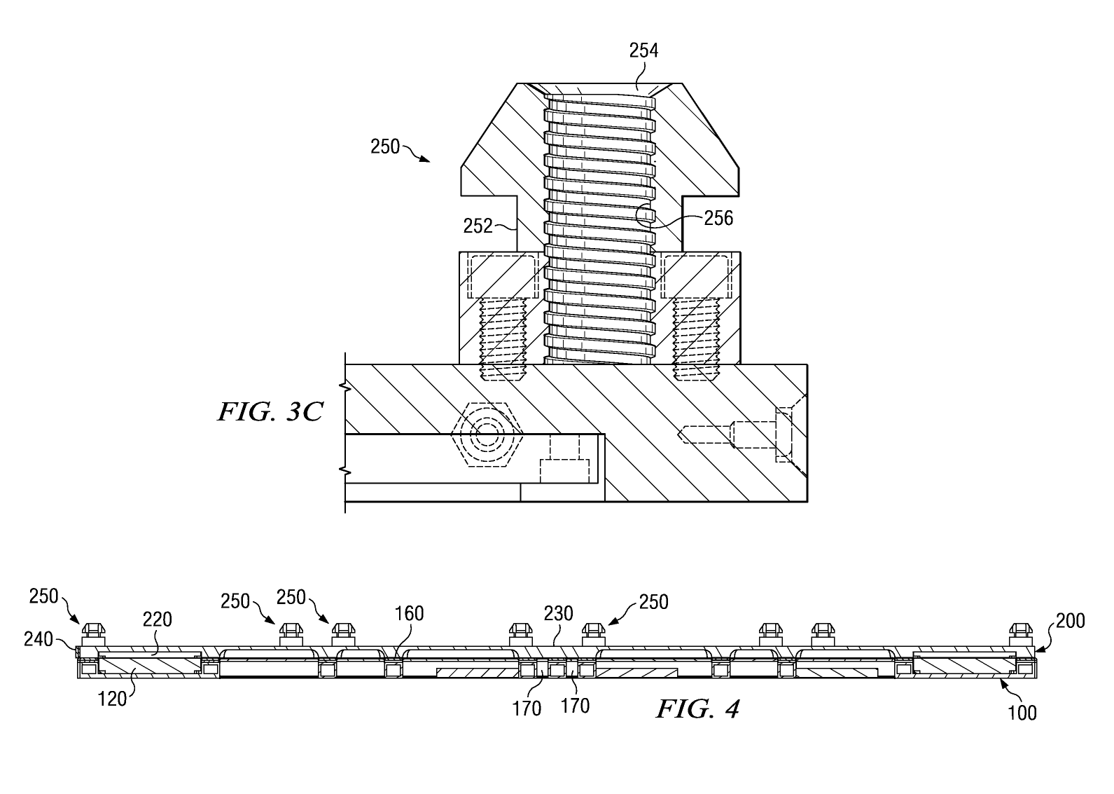

Referring to FIGS. 3a and 3b, the system also comprises a plurality of carriers 200 configured to couple with a cell module 100 in the storage area matrix 1, and configured to move between cell modules 100. The carriers 200, which, like the cell modules, define a substantially flat rectangular plate structure, comprise at least one magnet 210, 220 disposed on an underside of the carrier 200. The carriers 200 may comprise various sizes as desired by the user, or as dictated by the storage area in which the carriers 200 are incorporated. Referring to FIG. 4, the magnets 210 and/or 220 are configured to engage the linear synchronous motors 110 and/or 120 of the cell module 100 to secure the carriers 200 to the cell module 100 when the carriers 200 are at a rested position. As shown in the embodiment of FIG. 3b, the carriers 200 may comprise at least long drive magnet 210 that engages the long drive linear synchronous motor 110 of the cell module 100, and may also comprise at least one short drive magnet 220 that engages a short drive linear synchronous motor 120 of the cell module 100. Arranging the short drive 220 and long drive magnets 210 on the four sides of the carrier 200 ensures that the carriers are firmly secured in multiple directions. This is especially beneficial when the carriers are inside a storage area 1 of a ship that pitches and yaws unpredictably at sea. The magnets 210, 220 comprise various materials suitable to magnetically couple to a motor, for example, lanthanides, metals, transition metals, metalloids, and combinations thereof. In an exemplary embodiment, the magnets 210, 220 may comprise neodymium, iron, and boron. Suitable magnets may include the MC250 neodymium-iron-boron permanent magnet way produced by Kollmorgen, and which may be used with the ICC-250 iron core linear synchronous motors of the cell module 100.

In addition to securing the carriers 200, the motors 110, 120 of the cell module are also configured to transfer a carrier from one cell module to another cell module. In one exemplary embodiment of carrier 200 movement, the linear synchronous motors 110, 120 of a first cell module deliver a thrust force, which decouples the magnets 210, 220 from the motors 110, 120 and delivers the carrier 200 to a second cell module. Upon delivery to the second cell module, the carrier magnets 210, 220 engage the linear synchronous motors of the second cell module, thereby securing the carrier 200 to the cell module 100. In a specific embodiment, the carriers 200 are configured to move bi-directionally between cell modules in the X and Y directions. By providing linear synchronous motors at the four sides of the cell module 100, the motors may apply thrust forces in the X and Y directions, thereby facilitating movement of the carriers 200 in the X and Y directions.

In one exemplary embodiment, the magnetic attraction between iron-core linear synchronous motors 110, 120 and the permanent magnets 210, 220 is so strong that it may stabilize a carrier 200 supporting a cargo weight of up to 20,000 lbs or more, whether the carrier is at rest or moving between cell modules. In addition, the magnetic attraction is sufficient to stabilize these weights when the ship undergoes various types of ship movement induced by high seas states, such as roll, pitch, yaw, heave, etc. The degree of magnetic coupling strength may vary depending on the motors used. For example, and not by way of limitation, the iron core linear synchronous motors and neodymium-boron-iron magnets, when aligned and coupled, may have a magnetic attraction or down force of at least about 60,000 lbs.

Despite the durability of the carrier/cell module magnetic coupling, there is still a possibility that cargo or payloads, especially heavy cargo and payloads may tip over. For further stability, the cell modules 100 may, in a further embodiment, utilize a locking pin mechanism 130 as shown in FIG. 2a. In this embodiment, the locking pin 130 is a high strength steel pin that can be moved vertically a short distance to engage a tapered hole on the underside of the payload carrier (not shown). The locking pin mechanism 130 is housed in a conical steel support structure, and both the pin and tapered hole are tapered to facilitate engagement.

Referring to FIG. 2a, the cell modules 100 may, also comprise a power source, for example, an internal nickel-cadmium battery, fuel cell, or another suitable power source known to one of ordinary skill in the art. The cell modules 100 are designed to be independent units with each cell module comprising its own power source. In one embodiment as shown in FIG. 2a, the power source may comprise a power connector 152, and a power junction box 150 coupled to the power connector 152. In yet another embodiment, the cell module 100 may also comprise at least one programmable controller 140 responsive to a computer or processing unit and configured to regulate the movement of the carriers within the storage area. In one exemplary embodiment, the controllers comprise digital servo amplifiers 140, which regulate the motors and thereby regulate the movement of the passive carriers. For additional control capabilities, the cell modules 100, may in further embodiments, comprise Hall Effect feedback sensors 190 coupled to the motors 110 and/or 120, and computer interface boards 180. In operation, the Hall sensors 190 communicate with the amplifiers 140 and may also provide feedback to a control computer external to the cell module. The control framework of embodiments of the present invention will be discussed in detail below.

To reduce friction as a carrier 200 slides from one cell module 200 to another, the cell module 100 may comprise sliding bearings. Referring to the embodiment of FIGS. 2a and 2b, the sliding bearings may comprise friction reducing surfaces 160 covering at least partially the motors 110, 120 of the module 100. The friction reducing surfaces 160 may comprise any suitable material operable to minimize sliding friction as a carrier or another vehicle moves over the cell module 100. In one exemplary embodiment, the friction reducing surfaces 160 may comprise a fluoropolymer material, such as PFA or PTFE. In another exemplary embodiment, the surface 160 may comprise Rulon®. Alternatively, the bearings may also comprise ball transfer units or air bearings. Referring to the embodiment of FIG. 2c, the cell module 100 may comprise plenums 166 or openings arranged in the upper plate of the cell module 100. To produce a substantially frictionless air bearing surface on the top surface of the cell module 100, air is delivered through these plenums 166 via air bearing nozzles 162 and air supply lines 162 contained within the cell module 100. In a further embodiment as shown in FIG. 2c, the plenums 166 may be disposed within a friction reducing surface 160. By using multiple bearing types, the amount of thrust required in moving a carrier 200 is minimized.

Referring to FIG. 2b, the upper surface of the cell module 100 may also comprise tread panels 170 disposed on at least a portion of the upper surface of the cell module 100. These tread panels 170, which are typically comprised of rigid polymeric materials, are designed to provide a surface, which can support a carrier and payloads thereon, as well as other vehicles, such as forklifts Suitable materials may include, but are not limited to, the SAFPLANK® fiberglass/resin composite. Additional top plates or surfaces, e.g. stainless steel or aluminum plates, for the cell module are contemplated herein.

Turning to the carrier as illustrated in the embodiment of FIG. 3a, the upper surface of the carrier 200 may comprise a material sufficient to withstand heavy payloads disposed thereon. In one embodiment, the top side of the carrier 200 may comprise an aluminum plate 230. An aluminum plate 230, and specifically an aluminum plate having a thickness of about 1 inch to about 6 inches thick, is advantageous, because it can withstand heavy weights with minimal deformation and minimal material costs. In another exemplary embodiment, the aluminum plate 230 may comprise a thickness of less than an inch. The carrier 200 may also comprise sliding bearings 240 disposed at least partially along the edges of each of the carriers 200 and configured to guide the movement of the carriers 200. For example, when a carrier 200 is in motion, the sliding bearings 240 minimize friction as one carrier 200 slides against another carrier. The bearings may comprise air bearings, fluoropolymer surfaces, ball transfer units, and combinations thereof. In the embodiment of FIG. 3a, the bearings are guide surfaces 240 comprising a fluoropolymer, such as Rulon®.

The carrier 200 also comprises at least one engagement mechanism 250 disposed on a top side of the carrier 200 for coupling with a payload interface 300. The engagement mechanism 250 may comprise any suitable component for coupling with one or more payload interfaces 300 at various locations along the carrier surface 300. Referring to the embodiment of FIG. 3c, the engagement mechanism comprises a locking receptacle 250, configured to receive a locking insert of a payload interface 300. Although this receptacle 250 is discussed in the context of a carrier 200, the locking receptacle 250 may also be incorporated in a payload interface 300 or an omni-guided directional vehicle (OGV) 500 as described in detail below. As shown in FIG. 3b, the receptacles 250 are arranged such that the payload interfaces 300 may couple at a few different positions on the carrier 200. As shown in the embodiment of FIG. 3c, the receptacle 250 may define a substantially pyramidal structure comprising lateral grooves 252, an opening 254 at the top, and an internally threaded channel 256.

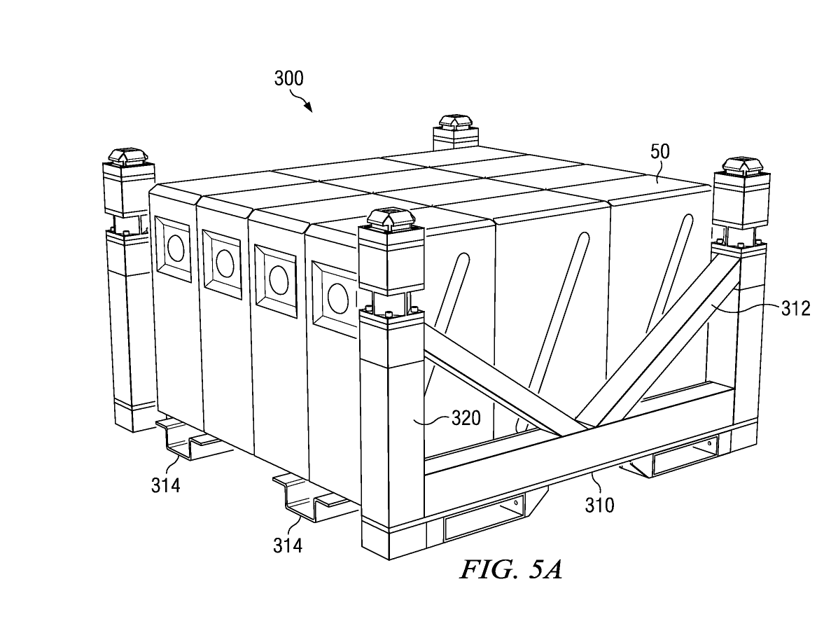

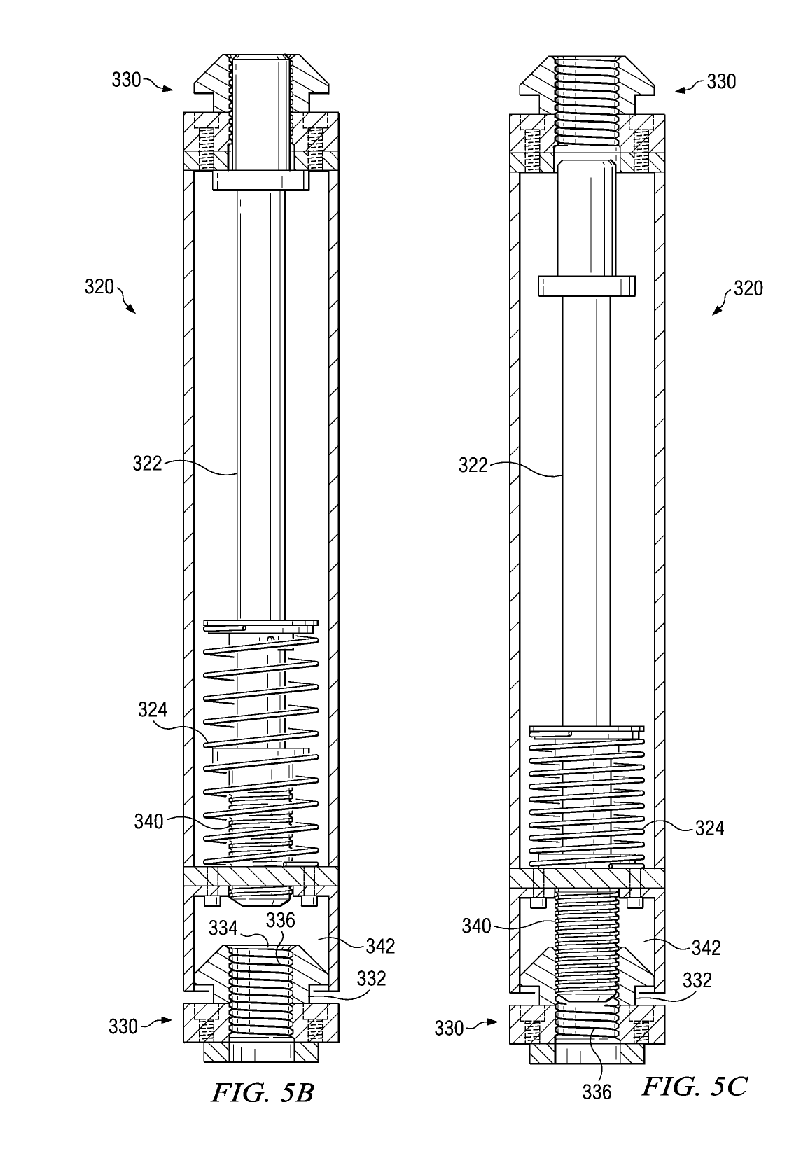

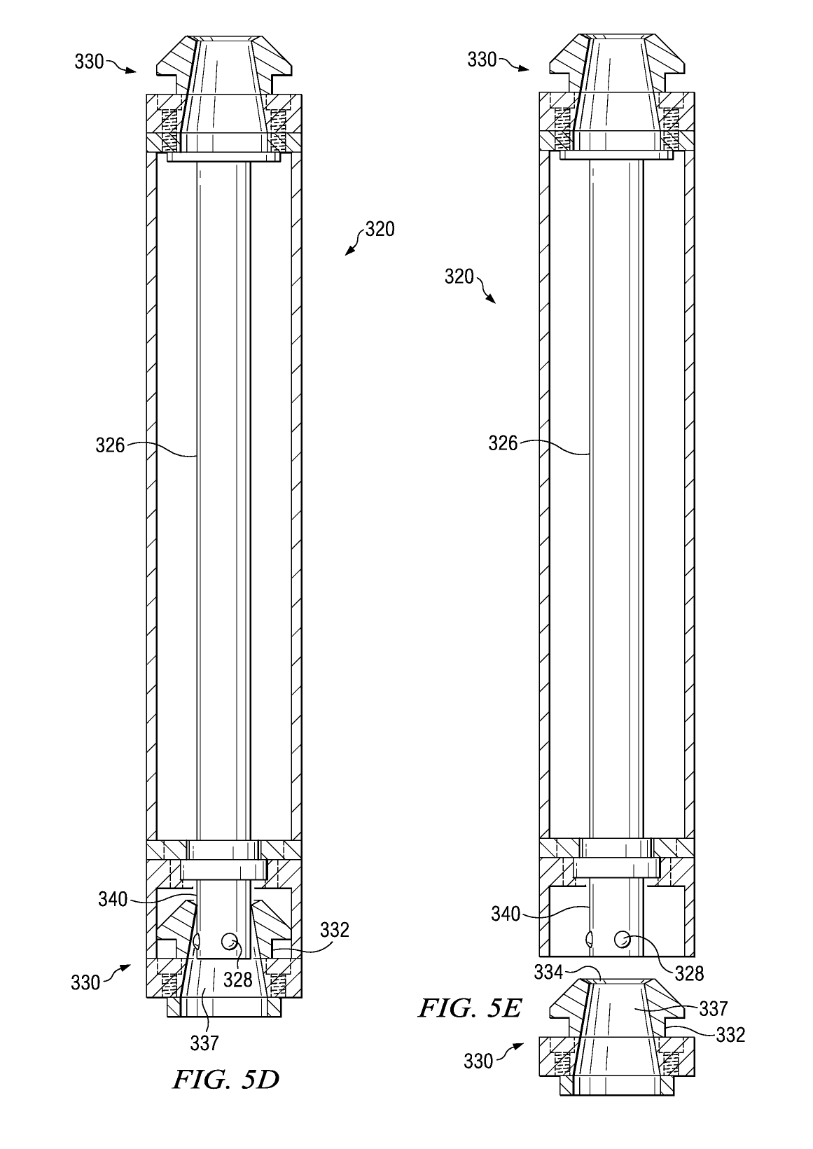

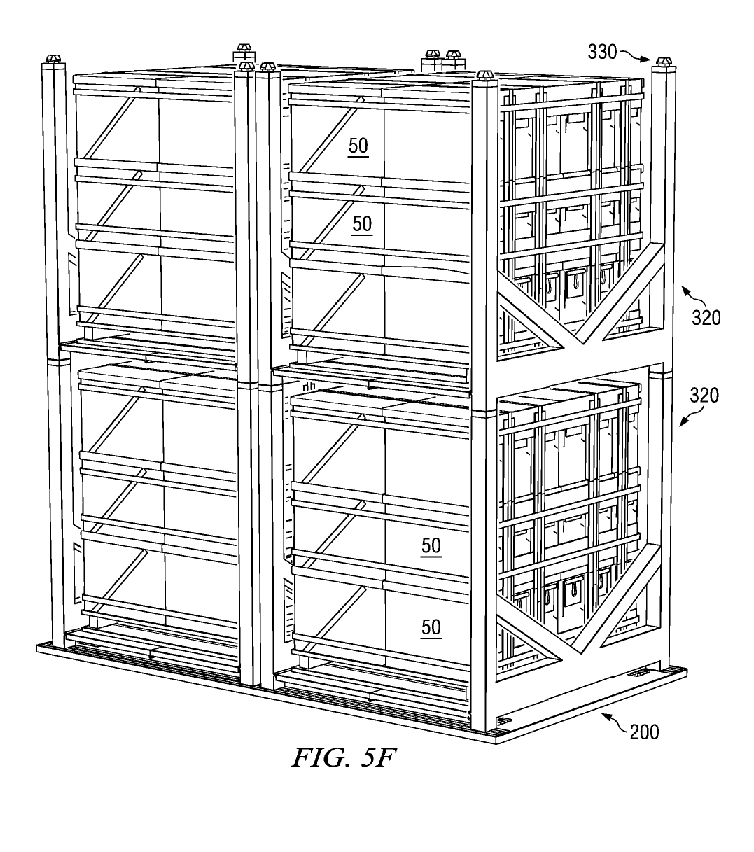

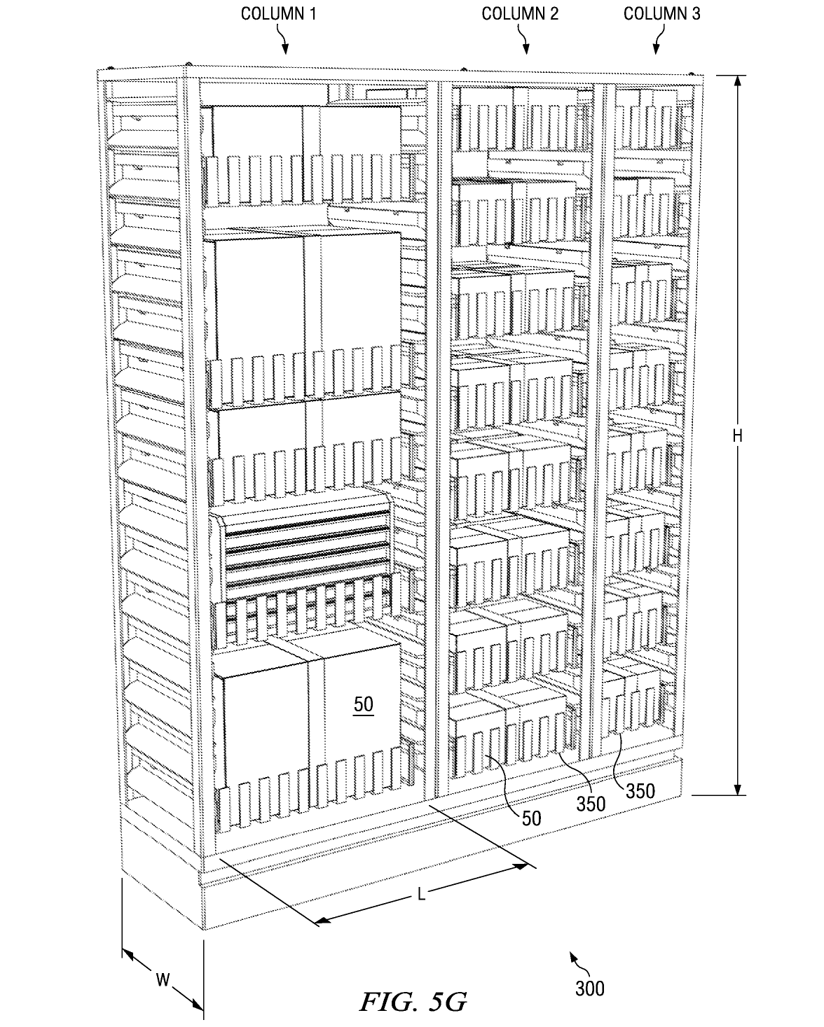

Referring to FIG. 5a, the payload interface 300, which is configured to provide access to and transport a desired payload 50, comprises a support frame 310 and a plurality of support stanchions 320 extending from a surface of the support frame 310. The frame 310 may comprise a platform or a plurality of intersecting beams arranged in a rectangular configuration. Other shapes and dimensions of the support frame 310 are contemplated herein. To provide additional structural support, the payload interface 300 may comprise additional cross beams 312. The support frame 310 may also contain a pair of channels 314, which accept forklift tines permitting the transport of payloads in a more traditional manner. Each support stanchion 320 comprises a locking receptacle 320 at one end of the stanchions 320, and a plurality of locking inserts 340 disposed at an opposite end of the support stanchions 320. The locking inserts 340 are configured to couple with a locking receptacle 250 of another carrier 200, or a locking receptacle 330 of another payload interface 300.

As shown generally in FIGS. 5a-5e, the stanchions 320 comprise rigid, non-moving rectangular structural tubes integral to the payload interface 300. For coupling purposes, each stanchion 320 utilizes a locking mechanism for example, screw-locks or ball-locks, with a rod/shaft 322, 326 that allows rotary tooling acting at the top end to engage a payload interface to an identical payload interface beneath it in a stack, or to fasten it to the carrier itself. Referring to the embodiments of FIGS. 5b and 5e, the locking receptacle 330 (or stanchion head) may define a tapered, pyramid-shaped structure on its top end with a threaded hole 334 as shown in FIG. 5b, or a conical cavity 337 as shown in FIG. 5e. On its opposite end, the stanchion 320 comprises a cup 342 having a moveable locking insert 340 extending therethrough. During engagement, the stanchion receptacle 330 is inserted into and engages the cup 342, and the locking insert 340, is inserted into the threaded hole 334 or conical cavity 337. These locking mechanisms provide stability for stacked payload interfaces, and shear loads, and provide guidance for the payload interfaces 300 during stacking operations.

In the screw-lock embodiments of FIGS. 5b and 5c, stanchions comprise extendible rods 322 with springs 324 surrounding the rods 322 in a coaxial arrangement. The rod 322 comprise a threaded locking insert 340 at its lower end, which extends downwardly and intermeshes with the internal threads 336 of a receptacle 330 of another payload interface 300 or carrier 200. Similar to the receptacle of the carrier, the springs 324 of the spring loaded support stanchions 320 are configured to compress upon engagement and decompress upon disengagement with the receptacle 330. Referring to FIGS. 5d and 5e, the ball lock mechanism includes a rod 326 having a locking insert 340 with extendable pin 328, disposed at its lower end. The extendable pin 328 is inserted into the conical cavity 337. By rotating the rod 326 and the extendible pin 328, the extendible pin interlocks with the cavity 337. When the pin 328 touches the upper edge of the cavity, the extendible pins 328 are forced inwardly into the rod, and the rod then extends downwardly into the cavity 337. The cavity 337 may comprise internal threads, which ensure stringer coupling with the extendible pin. For the screw lock or ball-lock mechanisms, the locking insert 340 may extend downwardly and extend downwardly to various depths within the threaded portion 334 or conical cavity, respectively

In further embodiments, the receptacle 330 may also incorporate slotted features that enable a robotic manipulator 400 (or other material handling device, such as a forklift or crane, outfitted with proper “top-lift” tooling) to securely lock onto a payload interface 300 (and its palletized or containerized load) to move it. As noted above, the stanchions are structural members. In one exemplary embodiment, adjacent stanchions may come into contact with one another and support the weight of certain types of stacked payloads, such as palletized goods and ready service weapons on transport skids, especially for payloads that are not designed to nest together, when stacked. For those payloads that are already designed to nest, when stacked, such as missile containers and bomb pallets, the payload interface stanchions 320 do not touch one another (i.e., carry no compression loads). The stanchion receptacles 330 are inserted into the cups 342 on the adjacent payload interface only deep enough to center the locking mechanisms during insertion. In this case, the locking mechanisms pull the two payload interfaces together tightly when engaged, fastening the unit load to a payload carrier or to another unit beneath it to form a rigid stack.

The payload interface 300 is comprised of a rigid polymer or metal material, which withstands stresses due to cargo weights and ship movement. In an exemplary embodiment of the present invention, the stanchions 320 are fabricated from steel tubing and the support frame 310 on which the stanchions 320 are mounted is formed from aluminum or steel sheet metal. In yet another exemplary embodiment, the support frame 310 measures 50 inches in length and 53 inches in width, providing a useable stowage area or payload “footprint” of 48 inches by 45 inches with space for four inch square stanchions 320. By varying the length of the steel tubing sections, stanchions 320 can be easily provided to users in a range in heights depending on the height of a particular containerized or palletized payload. Several standard stanchion heights may be produced to minimize the vertical space wasted between stacked payloads in the stowage system.

Referring to the embodiment of FIG. 5f, the payload interfaces 300 may be arranged in a stacked arrangement, wherein the locking inserts of an upper payload interface may be inserted into the receptacles of a lower payload interface. Furthermore, the payload components 50 disposed on the payload interfaces 300 comprise dimensions, which enable the payloads to be stacked on one another in a nested arrangement. As would be familiar to one of ordinary skill in the art, the box or container of the payloads may comprise projections on the payload surface 50, which enables the payload 50 to interlock or nest with another payload when stacked. The nested arrangement helps prevents payload sliding, especially when the storage area matrix pitches, yaws or heaves. Referring to the embodiment of FIG. 5g, the payload interface 300 may comprise multiple shelves 350, and/or multiple columns used to support cargo and payloads. As shown, the shelves 350 may comprise multiple heights, and lengths, and the columns may also comprise variable lengths for supporting various sizes of payload components 50.

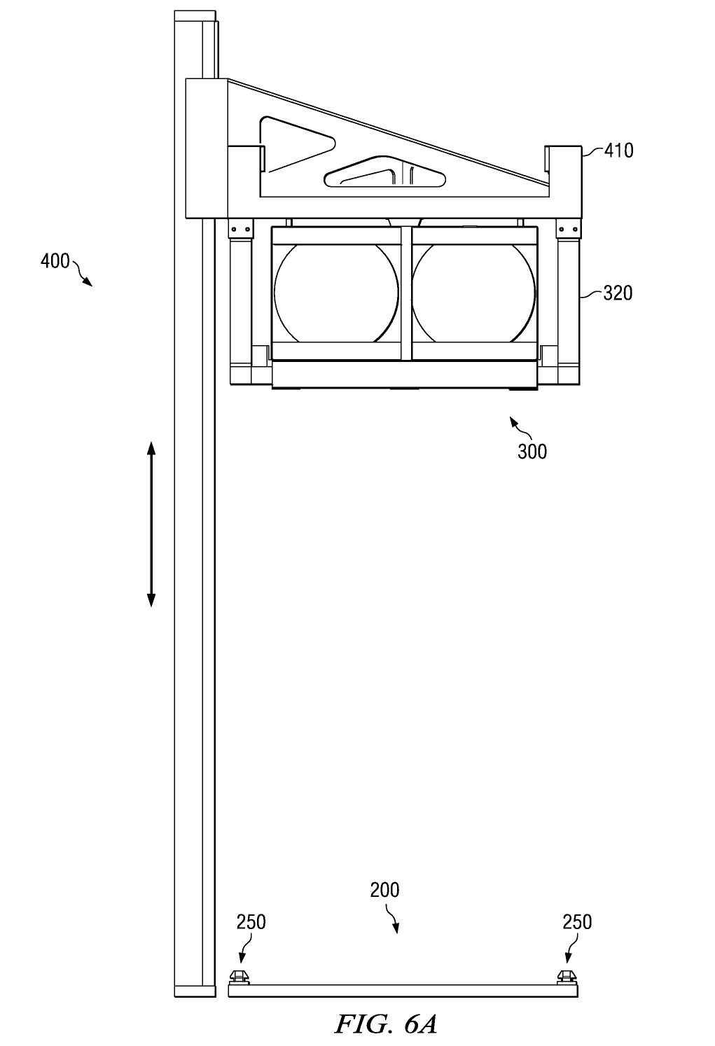

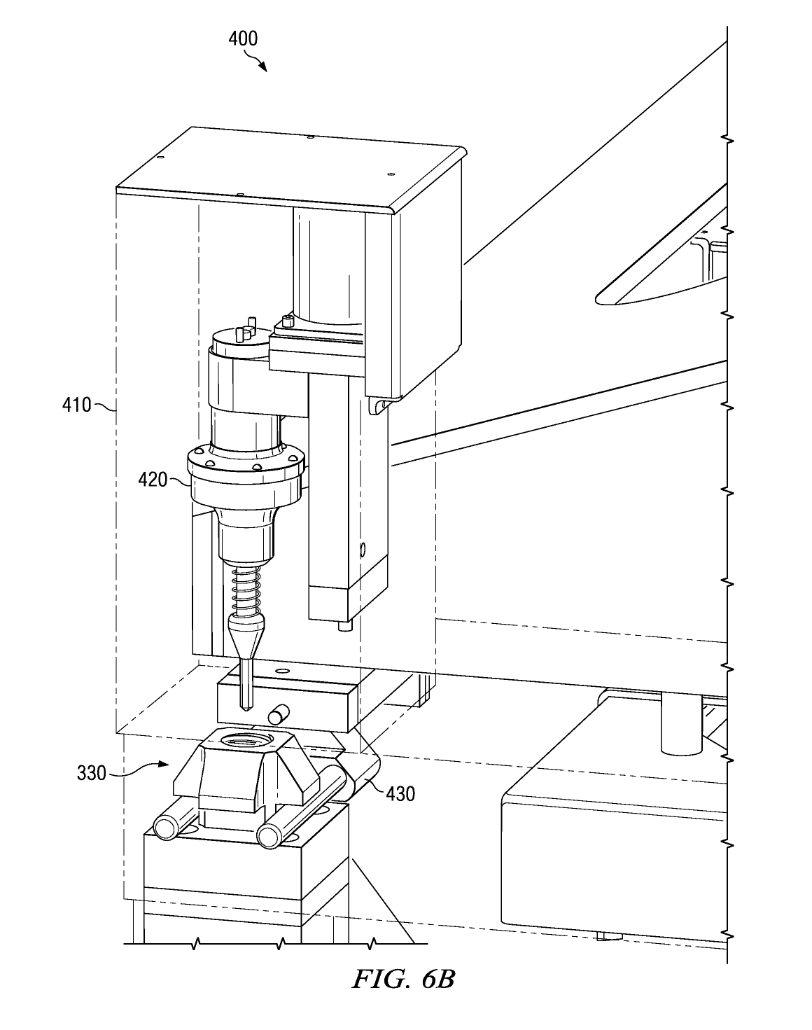

In another embodiment as shown in FIG. 1, the system also comprises a robotic manipulating unit 400 configured for the stacking and unstacking of payload interfaces 300 and/or payloads 50. Referring to the embodiments of FIGS. 1, and 6a, the robotic manipulating unit 400 is typically positioned along the wall of the storage area matrix 1 near a loading/unloading area 5; however, other positions within the storage area matrix are contemplated. The robot 400 is adapted to move vertically up and down. A greater range of motion for the robotic manipulating unit 400 is possible; however, this greater freedom of motion may decrease the amount of storage space available in the storage area matrix 1. Referring to FIG. 6a, the robotic manipulating unit 400 comprises a plurality of posts 410, which comprise actuators configured to engage and disengage at least one payload interface 300. By engaging the payload interface 300, the robotic manipulating unit 400 is operable to stack at least one payload interface on another payload interface or carrier, or de-stack a payload interface from another payload interface or carrier. Additionally, the robot 400 may receive a payload interface 300 from a vehicle, such as a forklift or an automated guided vehicle e.g. an omni-directional guided vehicle (OGV) 500, and may also deliver a payload interface 300 to a vehicle. Referring to FIG. 6b, the robotic manipulating unit 400 utilizes at least one actuator disposed on or within the plurality of posts 410. The actuators may be manually operated, or electrically powered, for example, by a brushless DC motor. One such actuator is a hex locking tool 420 comprising a rotatable screw operable to be inserted into the internal threads of a receptacle 330. Another actuator is a retractable locking pin assembly 430 comprising at least two locking pins that may extend into the lateral grooves of the receptacle 330. These two actuators 420 and 430, either singularly or in combination, enable the robotic manipulating unit 400 to lift a payload interface 300 off of a carrier, a vehicle, or another payload interface as shown in FIG. 6a.

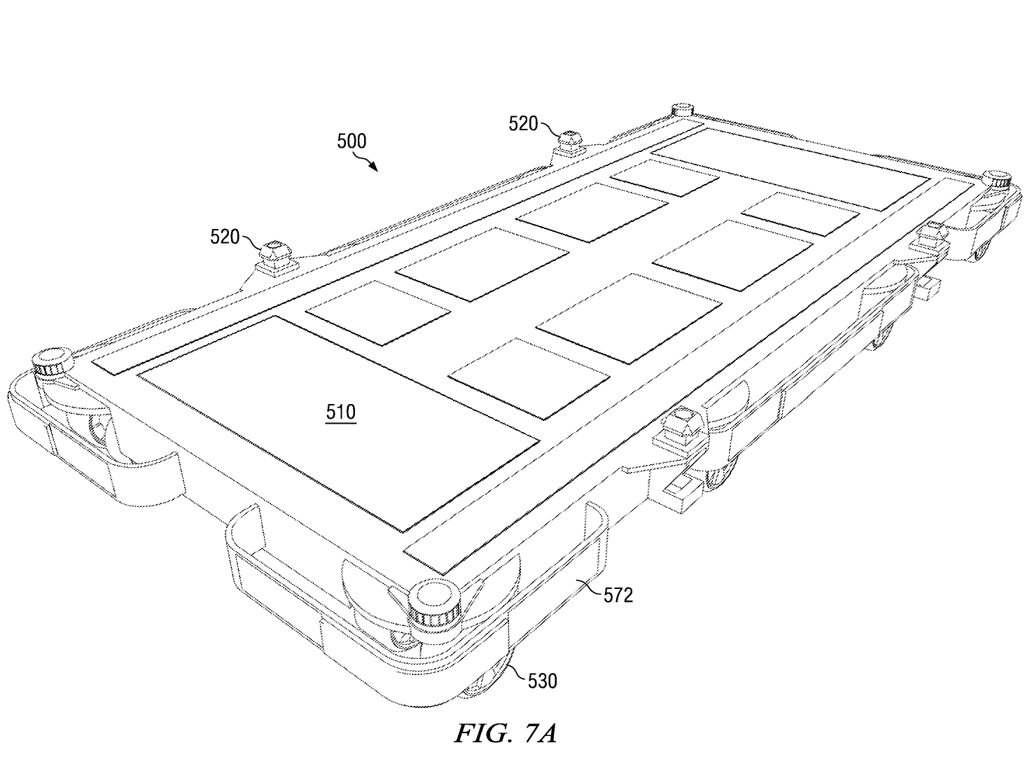

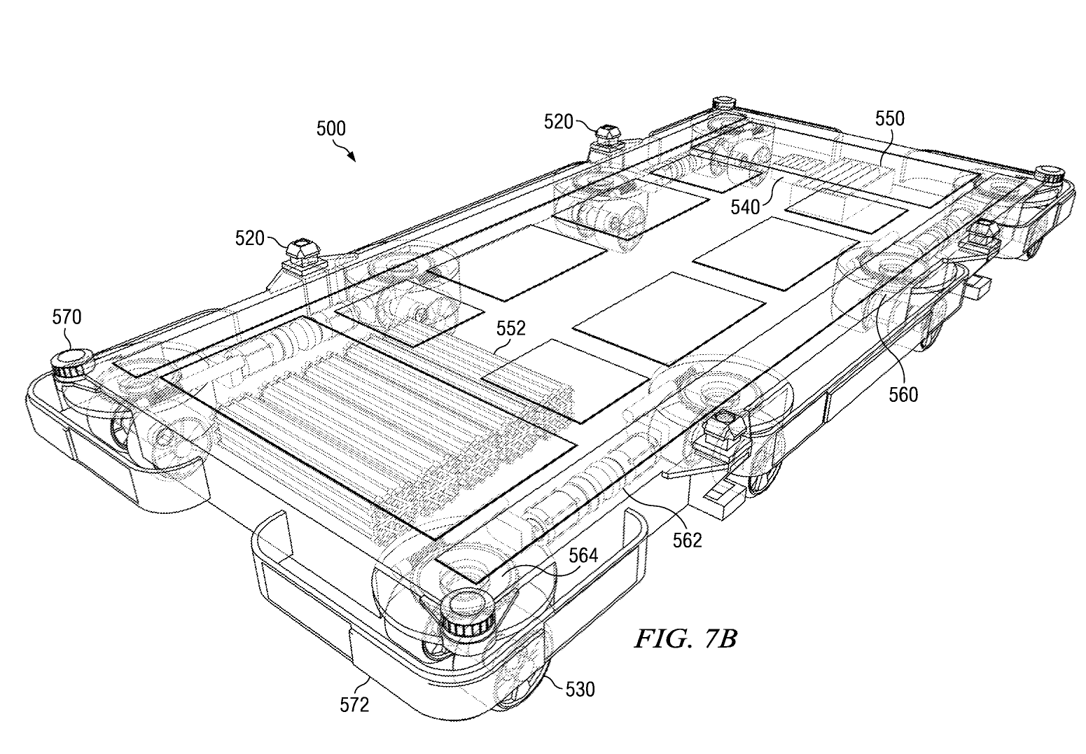

In addition to controlling the movement of cargo and payloads within the storage area matrix 1, the present system also controls the transport of payloads from a loading/unloading area 5 to a storage area matrix 1. As an alternative to elevator loading trays, forklifts, pallet jacks, or other lifting devices known to one of ordinary skill in the art, the system according to some embodiments of the present invention can further include a guided vehicle, e.g. an omni-guided directional vehicle (OGV) 500 configured to move a payload interface to and from the storage area matrix 1. Referring generally to FIGS. 1, 7a, and 7b, the OGV 500 is a compact automated guided vehicle operable to travel from a loading/unloading area 5 or other locations of a ship, and into the storage area matrix 1. The loading/unloading area 5 is defined as any location operable to receive cargo and payloads from the storage matrix or deliver cargo and payloads from the storage matrix, and includes any components used in the receipt and delivery e.g. elevators 800 and elevator loading trays therewith, etc. Because the OGV 500 defines a flat rectangular shape like the carrier 200, the OGV 500 occupies less space in the storage area matrix, and enables more payload interfaces to be stacked on it.

Referring to FIG. 7a, the OGV 500 may comprise a plurality of wheels 510, and a plurality of engagement mechanisms, e.g. receptacles 520, disposed along the top surface for coupling with a payload interface 300. Since the OGV 500 must support significant payload and cargo weights, the OGV 500 must comprise a rigid upper plate 510. The upper plate 510 may comprise a metal such as aluminum, or a rigid polymer, such as the thermoset resin used in the tread panels of the cell module 100. Referring to the OGV internal component schematic of FIG. 7b, the OGV 500 comprises an electronics control panel 550 that regulates the OGV power source, which may include but is not limited to, a fuel cell 552, or a battery module e.g. a nickel-cadmium battery pack. The OGV 500 may also comprise various wheel drive and steering components, for example, and not by way of limitation, a dual-wheel drive assembly 564 comprising a DC motor and at least one planetary gear, a wheel steering unit 562 comprising a DC motor and worm gear, and a hydrostatic suspension 560. The OGV 500 may also comprise at least one sensor for determining its location. These may include at least one position sensor 570, e.g. an acoustic proximity sensor or a laser sensor, and a contact sensing bumper 572 disposed at least partially along the edges of the OGV 500. If the sensors 570 or sensing bumper 572 detects a carrier 200 or other obstacle in its travel path, the OGV 500 is able to self-correct the travel path. To regulate the various functions of the OGV 500, the OGV 500 comprises a computer control unit 550 operable to regulate the location sensors, navigate the travel path of the OGV 500, communicate with the control framework of the system, etc. As shown in FIG. 1, the primary task of the OGV 500 is receiving at least one payload interface 300 from a loading/unloading area 5, for example, via an elevator loading tray. After receiving the payload interface 300, the OGV 500 delivers the payload interface 300 to the robotic manipulating unit 400 of the storage area matrix 1, and the robot 400 places the payload interface 300 on a carrier 200. As stated above, the OGV 500 is also able to deliver payload interfaces from a storage area matrix 1 back to a loading/unloading area 5.

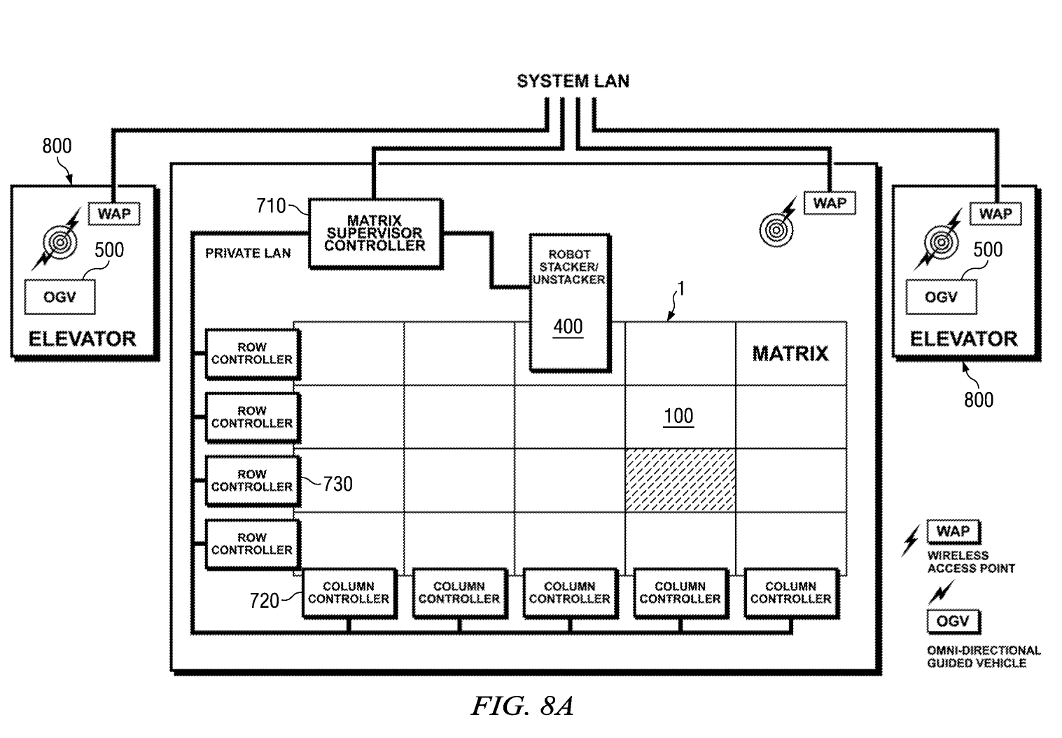

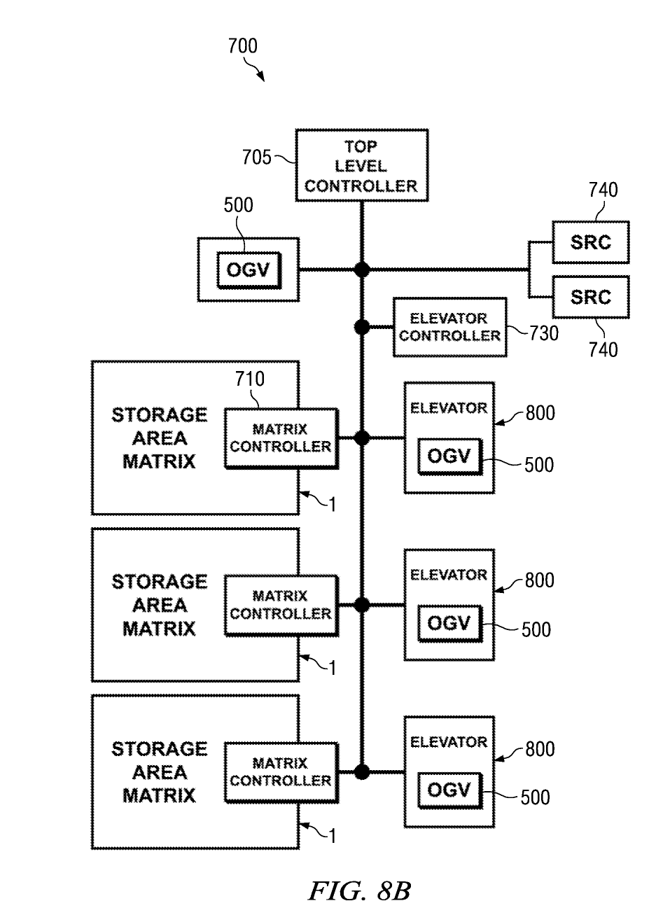

In order to integrate these various components into a cohesive system, the present storage area matrix embodiment 1 utilizes a sophisticated control framework. Referring to the embodiment of FIG. 8a, the control framework is a hierarchical arrangement comprising at least one matrix supervisory controller 710, which regulates column controllers 720 and row controllers 730 arranged along the columns and rows, respectively, of the storage area matrix 1. In one embodiment, the row 730 and column 720 controllers may communicate with the interface boards 180 of the cell modules 100. By communicating with the cell modules, the controllers 720, 730 are able to regulate the movement of the carriers within the storage area matrix 1. The row 730 and column 720 controllers provides redundancy in the control framework, so that, for example, if a column controller 720 fails, the row controllers 730, which intersect with the malfunctioning column controller 720, are able to compensate. Additionally, the matrix controller 710 also may regulate the movement of payloads from the elevators 800 to the matrix 1 via the OGV 500, and may control the robot manipulating unit 400 configured for stacking and unstacking payload interfaces 300. Other responsibilities include maintaining an inventory database, monitoring system performance/diagnostics, and scheduling preemptive maintenance. To track and maintain the inventory within the storage area matrix 1, the payload interface 300 and/or payload components 50 may comprise tracking indicia, which may be read by the controllers 710, 720, and 730. As defined herein, “tracking indicia” includes bar codes, RFID tags, UV identifiers, IR identifiers, and combinations thereof. This control system, as shown in FIG. 8a, may be maintained as an independent, self-contained entity, and is operable to be installed in any storage area.

Alternatively as shown in FIG. 8b, the matrix supervisory controller 710 may itself be regulated by a top level controller 705 as part of an overall (e.g. vessel) control system 700. The top level controller 705 is configured to regulate the supervisory controllers 710, as well as other operations and sectors of a ship or aircraft carrier. For instance, the top level controller 705 may regulate an elevator controller 730, which regulates the elevators 800 in a loading and unloading area 5, and may also regulate the shipping and receiving controllers (SRC) 740. The shipping and receiving controllers 740 are controllers regulating the movement of cargo and payloads on a separate vessel, e.g. a replenishment ship, or external dock or warehouse. In additional embodiments, the robotic manipulating unit 400, and/or the OGV may also comprise its own controllers. As shown in FIG. 8b, the top level controller 705 regulates the activity of all other controllers, such that the system hardware and software components are properly integrated into the system. As shown in FIGS. 8a and 8b, all the controllers may be wirelessly connected to one another through wireless access points located at numerous points throughout the vessel, wherein each wireless access point communicates with a wireless area network. Additionally, the control system 700 also utilizes software programs and programmable logic to interconnect the various components and controllers of the present system. The software architecture of the control system 700 is within the scope of some aspects of the present invention.

Summarizing an exemplary embodiment of the automated stowage and retrieval system, the top level controller 705 on an aircraft carrier or other ship sends a signal to an SRC controller 740 on a replenishment ship requesting delivery of payloads from the replenishment ship to a storage area matrix 1 of an aircraft carrier. After receiving the request, the SRC controller summons at least one OGV 500 to begin delivering payload interfaces 300 with payloads thereon from the replenishment ship to an elevator 800 of the loading and unloading area 5. The elevator controller 730 then mandates delivery of these payload interfaces to an OGV 500 via an elevator loading tray, forklift, etc. The supervisory matrix controller 710 then prepares the storage area matrix 1 for delivery. The matrix controller 710 consults its inventory database and determines what cell module 100 should support these new payload interfaces. The matrix controller 710 then signals a plurality of cell modules to move at least one of the carriers in anticipation of the new payload interfaces. The OGV 500 delivers the payload interfaces to the robotic manipulating unit 400. The robot 400 decouples the payload interfaces 300 from the OGV and couples the payload interfaces 300 to a carrier 200. In accordance with the slide puzzle algorithm, this carrier 200 and other carriers move in tandem so that the new payload interfaces may be delivered to the desired cell module identified by the matrix controller 710.

It is noted that terms like “generally”, “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the terms “substantially” and “about” are utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Having described certain illustrative embodiments of the invention, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. Moreover, although multiple inventive aspects are described herein, such aspects need not be utilized in combination in any given embodiment.

What is claimed is:

1. An automated stowage and retrieval system comprising:
a storage area comprising a plurality of stationary cell modules arranged in a matrix, wherein each cell module comprise at least one motor; and
a plurality of carriers comprising at least one magnet disposed on an underside of each of the carriers and at least one engagement mechanism for a payload interface disposed on a top side of each of the carriers, the at least one magnet being configured to firmly secure the at least one motor of a corresponding cell module with a down force;
wherein the at least one motor is configured to move the carrier within the storage area and is also configured to firmly secure the carrier when the plurality of carriers are at a rested position with a down force.

2. A system according to claim 1 further comprising at least one payload interface configured to support a desired payload, wherein the at least one payload interface comprises at least one engageable mechanism configured to couple with the at least one engagement mechanism of the carrier.

3. A system according to claim 2 wherein the at least payload interface engages the carrier by a ball lock mechanism or screw lock mechanism.

4. A system according to claim 2 wherein the at least one payload interface comprises multiple shelves configured to support various sizes of payload components.

5. A system according to claim 2 further comprising a robotic manipulating unit configured to engage and disengage the at least one payload interface in order to move the payload interface.

6. A system according to claim 2 further comprising a guided vehicle configured to deliver the at least payload interface from a loading/unloading area to the storage area matrix.

7. A system according to claim 1 further comprising at least one programmable controller responsive to a computer or processing unit and configured to regulate the movement of the carriers within the storage area.

8. A system according to claim 1 further comprising a control framework comprising a matrix supervisory controller and plurality of programmable controllers disposed at each row and column of the storage area matrix responsive to the matrix supervisory controller.

9. A system according to claim 1 wherein the at least one carrier are configured to move bi-directionally by sliding in the X and Y axes.

10. A system according to claim 1 wherein the motors are linear synchronous motors, and wherein the motors engage the magnets by magnetic coupling.

11. A system according to claim 1 wherein the magnets comprise lanthanides, metals, transition metals, metalloids, and combinations thereof.

12. A system according to claim 1 wherein the top side of each of the carrier is an aluminum plate.

13. A system according to claim 1 further comprising sliding bearings disposed at least partially along the edges of each of the carriers and at least partially on the top surface of each of the cell modules.

14. A system according to claim 13 wherein the bearings comprise air bearings, fluoropolymer surfaces, ball transfer units, and combinations thereof.

15. The system of claim 2 wherein the payload interface comprises:
a support frame configured to support a payload;
a plurality of support stanchions extending from a surface of the support frame, wherein each stanchion comprises a locking receptacle at one end of the stanchion, a locking insert disposed at an opposite end of the stanchion, and an extendible rod connecting the locking insert and locking receptacle, wherein the locking inserts are configured to engage a locking receptacle of a payload carrier and a locking receptacle of another payload interface.

16. The system of claim 15 wherein the stanchions are spring loaded, the springs being configured to compress upon engagement with another payload interface or carrier and decompress upon disengagement.

17. The system of claim 15 wherein the locking receptacle is configured to couple with a locking insert of a robotic manipulating unit

18. The system of claim 15 wherein the receptacles and inserts are lockingly engaged via a screw lock mechanism or a ball lock mechanism.

19. The system of claim 15 wherein the payload interface is configured to support a plurality of payload components in a stacked arrangement, the payload components being dimensioned such that the payload components interlock with one another.

20. (canceled)

21. A method of moving carriers between cell modules of a storage area matrix comprising:
providing a first cell module comprising at least one motor, a second cell module comprising at least one motor, and a carrier comprising at least one magnet which is magnetically coupled to the at least one motor of the first cell module; and
transferring the carrier from the first module to the second cell module by delivering a thrust force from the at least one motor of the first cell module, wherein the thrust force decouples the at least one magnet from the first motor and delivers the carrier to the second cell module for subsequent magnetic coupling of the at least one magnet to the at least one motor of the second cell module.

22. A method of claim 21 wherein motors comprise linear synchronous motors, and wherein the magnetic coupling between the at least one linear synchronous motor and the least one magnet of the second cell module is operable to stabilize the payload carrier when it supports a weight of at least about 20,000 lbs.

23. The system of claim 1 wherein the motor is configured to deliver a thrust force to decouple the magnet of the carrier from the motor of the cell module.
